(19) United States
(12) Patent Application Publication
(10) Pub. No.: US 2003/0213141 A1
(43) Pub. Date: Nov. 20, 2003

(54) End hook of a measuring tape

(76) Inventor: Ping-Lin Lin, Taipei Hsien (TW)

Correspondence Address: RABIN & BERDO, P.C., Suite 500, 1101 14th Street, N.W., Washington, DC, 20005, US

(21) Appl. No.: 10/143,964

(22) Filed: May 14, 2002

(51) Int. Cl. G01B 3/10

(52) U.S. Cl. 33/758

(57) ABSTRACT

An end hook of a measuring tape has a bent end hook and a protective piece, each with at least one strike concave body slightly in a long elliptical shape disposed thereof respectively; a central hole is disposed on the strike concave body. Two long holes are disposed on the end portion of the rule strap opposite the end hook, corresponding to the strike concave body. The strike concave body on the end hook penetrates through the long hole of the rule strap and aligns with the upper aspect of the strike concave body of the protective piece. The rivet penetrates the long hole on the rule strap from the central hole and is riveted to the lower rim of the central hole of the protective piece thereby fastening the end hook and the protective piece into one unit.

### BACKGROUND OF THE INVENTION

1) Field of the Invention

The present invention relates to an end hook of a measuring tape, more especially to an end hook designed to buffer the cut from an end hook to a rivet and to reduce the shaking and swaying of the end hook due to a loose rivet which might lead to a deviation in getting a precise measurement. Particularly, corresponding strike concave bodies are disposed on the end hook main body and a protective piece to align with each other and to be riveted. An arc on the strike concave body pushes toward a long hole on a rule strap to tremendously reduce the shaking and swaying situation as well as the damage to the rivet so as to enhance the useful life and the measuring precision of the present invention.

2) Description of the Prior Art

Accordingly, a conventional end hook of a measuring tape, as shown in FIG. 7, mainly has an end hook (50) bent into an upside down shape of “7”, wherein the end hook (50) is disposed with two long holes (51) on a plate plane parallel to a rule strap (70). A rivet (60) penetrates the rule strap (70) from the long hole (51) and rivets the end hook (50) and the rule strap (70) respectively. Usually, a protective piece is added to the lower aspect of the rule strap (70), but it is not shown in FIG. 7. The rule strap (70) and the protective piece are fixed and not movable. However, the rivet (60) penetrated the long hole (51) of the end hook (50) allows the end hook (50) to move in the long hole (51) in a certain distance. The length of the moving distance is the thickness of the bent plate at the front end of the end hook (50) thereby providing a certain precision for the end hook (50) of the measuring tape during the pulling or pushing procedure. However, after a certain period of application, as shown in FIG. 8, the end hook (50) moving on the rule strap (70) causes a shearing force toward the rivet (60); the frequent cutting and striking force toward the rivet (60) tends to result in slanting and gapping situation which shakes and sways the end hook (50), or even loosens, breaks or damages the parts. These are the main shortcomings of the conventional product.

Furthermore, the width of the long hole (51) of a loosened rivet (60) is longer than the diameter of the rivet (60), as shown in FIG. 9, thereby causing very obvious left and right rotation of the end hook (50) and affects the measuring precision. That is another shortcoming of the conventional product.

### SUMMARY OF THE INVENTION

Therefore, the primary objective of the present invention is to design a bent end hook and a protective piece to be disposed respectively on an upper and a lower lateral sides of a rule strap and riveted by a rivet. On the bent plane of the bent end hook parallel to a rule strap is disposed with at least one strike concave body slightly in a long elliptical shape; a central hole is disposed on the strike concave body. The protective piece is formed in a proper shape; especially, the same number of strike concave body and central hole are disposed thereon correspondingly to those on the end hook. Two long holes are disposed on the end portion of the rule strap opposite the end hook. Two lateral sides of the long holes are parallel and the end portions thereof are arcuate. The convex portion on the back side of the strike concave body on the end hook penetrates through the long hole of the rule strap and aligns with the upper aspect of the strike concave body of the protective piece. The rivet penetrates the long hole of the rule strap from the central hole of the end hook and rivets the lower rim of the central hole of the protective piece to fasten the end hook and the protective piece into one unit such that it is capable of sliding on the rule strap and allowing the end hook to use the elliptical end on the outer rim of the strike concave body to push the arcuate area of the long hole so as to buffer the strike force and prevent the end hook from loosening.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is an exploded drawing of the present invention.

FIG. 2 is an external front view drawing of the present invention.

FIG. 3 is an external rear view drawing of the present invention.

FIG. 4 is a cross-sectional view drawing of the assembly of the present invention.

FIG. 5 is a drawing of the movement of the present invention.

FIG. 6 is a drawing of a strike concave body moving in a long hole on a rule strap of the present invention.

FIG. 7 is an external view drawing of the structure of an end hook of a conventional product.

FIG. 8 is a cross-sectional view drawing of the structure of the end hook of the conventional product.

FIG. 9 is a schematic drawing of the rotary situation generated by the end hook of the conventional product.

### DETAILED DESCRIPTION OF THE PREFERRED EMBODIMENTS

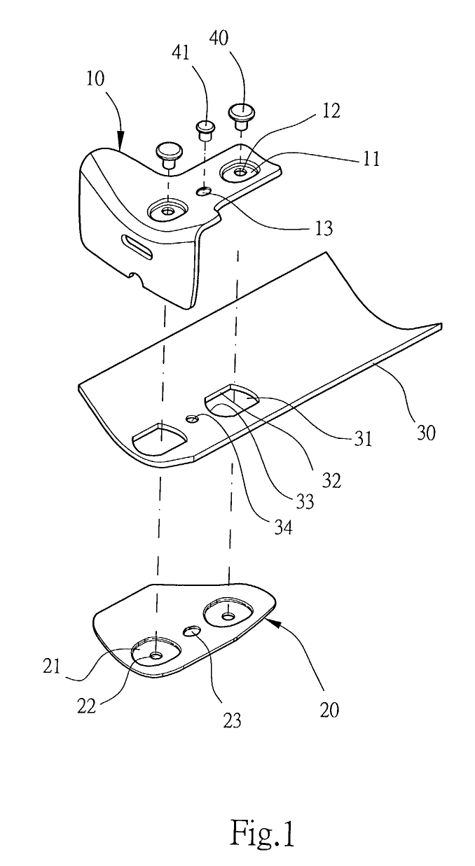

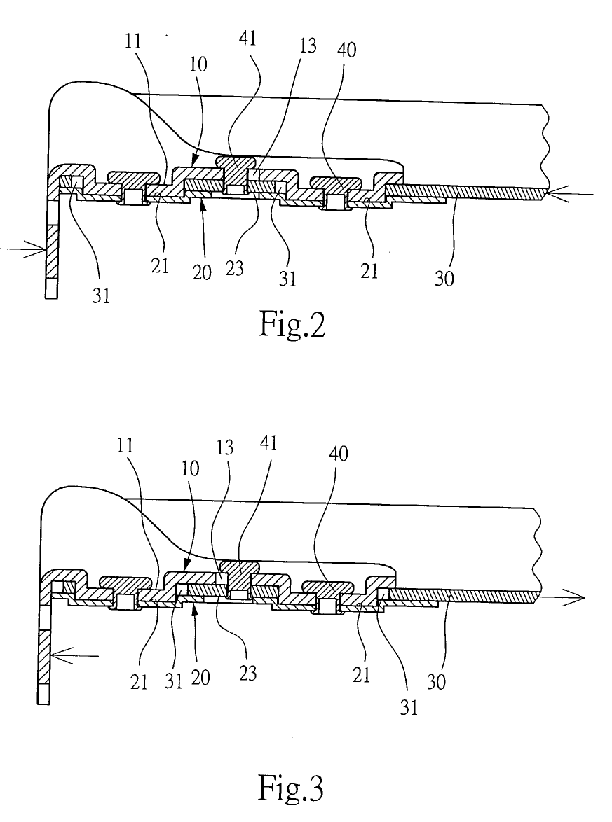

Referring to FIGS. 1, 2 and 4, the present invention comprises a bent end hook (10) and a protective piece (20) respectively disposed on an upper and a lower lateral sides of a rule strap (30) as well as riveted by a rivet (40). The present invention is characterized that a bent plane of the bent end hook (10) parallel to the rule strap (30) is disposed with two strike concave bodies (11) slightly in a long elliptical shape; two lateral sides of the two strike concave bodies are parallel and a central hole (12) is disposed on the bottom plane thereof; furthermore, a long cotter hole (13) is disposed between two strike concave bodies (11) or on other proper positions.

The protective piece (20) is formed in a proper shape and, especially, has the same number of strike concave body (21) and cotter pin (23) disposed correspondingly to those on the end hook (10); a central hole (22) is disposed on each strike concave body (21) and a long cotter hole (23) is disposed between the two strike concave bodies (21) or on other proper positions.

Two long holes (31) are disposed on the end portion of the rule strap (30) opposite the end hook (10); two lateral sides of the long hole (31) are parallel sides (32); an arc (33) is formed on the two end portions thereof and a fastening hole (34) is disposed between the two long holes (31).

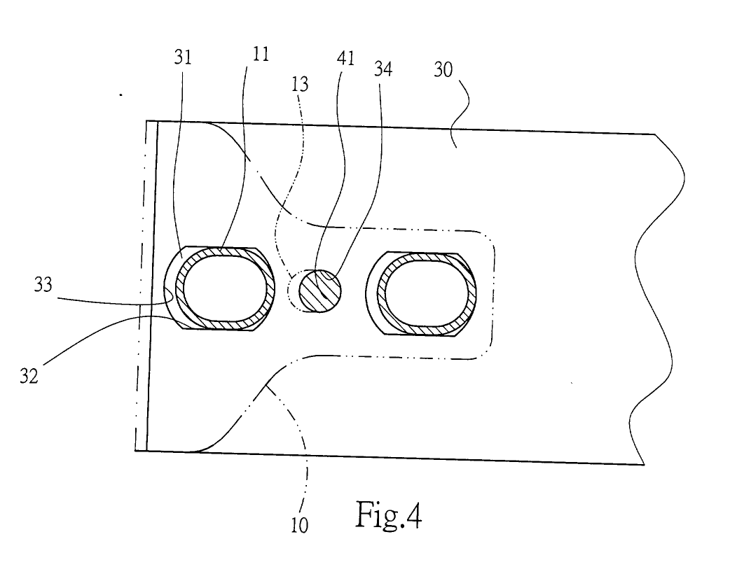

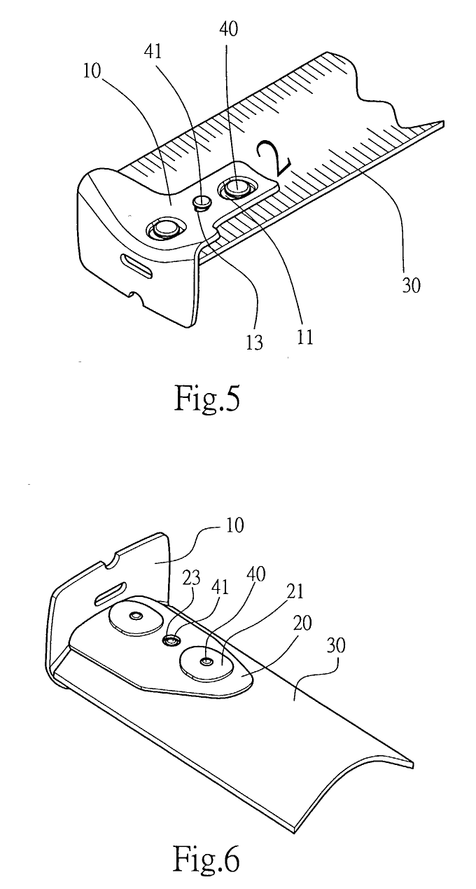

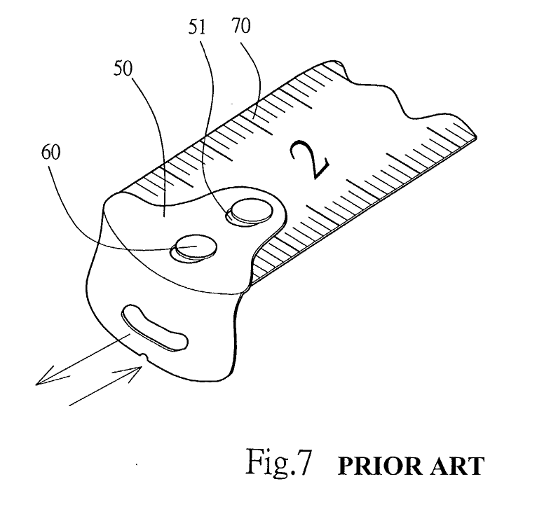

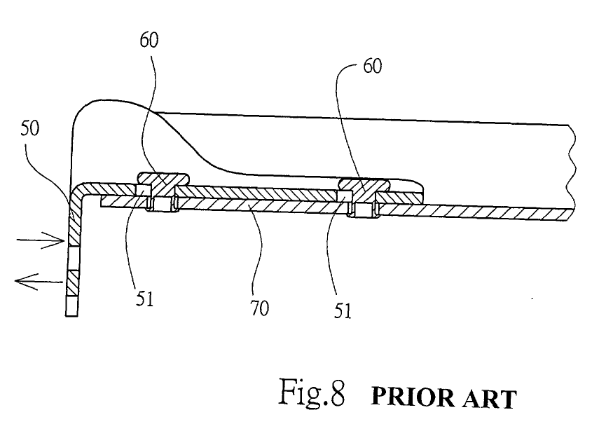

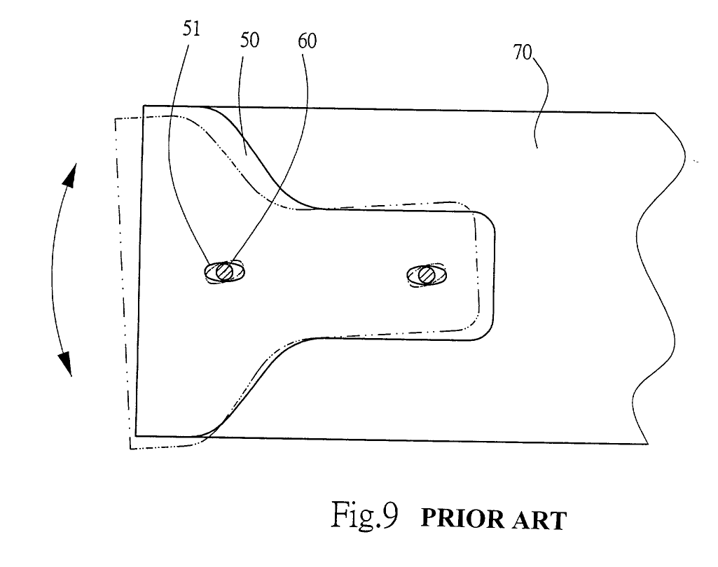

Referring to FIGS. 1, 2 and 5, a convex portion on the back side of the strike concave body (11) on the end hook (10) penetrates the long hole (31) of the rule strap (30) and aligns with the upper aspect of the strike concave body (22) of the protective piece (20). The rivet (40) penetrates the long hole (31) of the rule strap (30) from the central hole (12) of the end hook (10). As shown in FIG. 6, the rivet (40) rivets the lower rim of the central hole (22) of the protective piece (20) to fasten the end hook (10) and the protective piece (20) into one unit thereby it is capable of sliding on the rule strap (30) in a fixed distance. Particularly, the end hook (10) uses the outer rim of the strike concave body (11) to slide in the long hole (31) of the rule strap (30), as shown in FIG. 4, and uses the elliptical end of the strike concave body (11) to strike the arc (33) area of the long hole (31) so as to buffer the strike force. Furthermore, the parallel areas on the two lateral sides of the strike concave body (11) align fitly with the parallel sides (32) of the long hole (31) thereby allowing the end hook (10) to move back and forth but not rotate left and right.

Cotter holes (13, 23) in long elliptical shapes are disposed between two strike concave bodies (11, 21) located on the end hook (10) and the protective piece (20). The fastening hole (34) is correspondingly disposed on the rule strap (30). The rivet (40) penetrates the end hook (10), the cotter holes (13, 23) and the fastening hole (34) of the rule strap (30) and the protective piece (20) such that it shares a part of the strike force on the rule strap (30) generated from the end hook (10) and the protective piece (20). Under the situation of having the strike force evenly bore by a plurality of parts, the end hook (10) is not subjected to damage, relatively. That is the uniqueness of the present invention.

With those special designs, the application of the present invention has the following advantages:

1. After being connected, the strike concave body with the arc end disposed on the end hook and the protective piece of the present invention bears the push between it and the long hole of the end hook to efficiently reduce the stress and protect the most damageable rivet from greater shearing force such that the end hook is not subjected to move loosely up and down.

2. That both ends of the strike concave body and the long hole on the rule strap are arcuate and the two central sides are parallel only allowing backward and rearward movement but not left and right rotation.

3. The cotter holes in long elliptical shapes are disposed between two strike concave bodies on the end hook and the protective piece; a fastening hole is disposed on the rule strap correspondingly; the rivet penetrates two cotter holes and the fastening hole of the end hook, the rule strap and the protective piece thereby sharing a part of the strike force on the rule strap generated from the end hook and the protective piece. Relatively, under the situation of having a plurality of parts to evenly bear the strike force, the end hook is not subjected to damage.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An end hook of a measuring tape mainly comprising:
a bent end hook and a protective piece are disposed respectively on an upper and a lower lateral sides as well as riveted by a rivet; the present invention is characterized that the bent plane of the bent end hook parallel to a rule strap is disposed with at least one strike concave body slightly in a long elliptical shape; a central hole is disposed on the strike concave body;
the protective piece is formed in a proper shape; especially, the same number of strike concave body and central hole are disposed thereon correspondingly to those on the end hook;
two long holes are disposed on the end portion of the rule strap opposite the end hook; the two lateral sides of the long holes are parallel and the two end portions thereof are arcuate; the convex portion on the back side of the strike concave body on the end hook penetrates the long hole of the rule strap and aligns with the upper aspect of the strike concave body of the protective piece; the rivet is riveted to the lower rim of the central hole of the protective piece to fasten the end hook and the protective piece into one unit such that it is capable of sliding on the rule strap and making the end hook to use the elliptical end on the outer rim of the strike concave body to push the arcuate area of the long hole so as to buffer the strike force.

2. An end hook of a measuring tape according to claim 1, wherein the number of the strike concave bodies disposed on the end hook and the protective piece can be two or more than two.

3. An end hook of a measuring tape according to claim 1, wherein cotter holes in a long elliptical shape are disposed between two strike concave bodies on the end hook and the protective piece or on other proper positions; the rule strap has a fastening hole disposed relatively; the rivet penetrates the two cotter holes and the fastening hole of the end hook, the rule strap and the protective piece for securing to make the rivet bear a part of the strike force on the rule strap generated from the end hook and the protective piece.

4. An end hook of a measuring tape according to claim 1, wherein, the two lateral sides of the strike concave bodies in a long elliptical shape are parallel.
